(19) United States
(12) Patent Application Publication
(10) Pub. No.: US 2010/0229050 A1
(43) Pub. Date: Sep. 9, 2010

(54) APPARATUS HAVING FIRST BUS AND SECOND BUS CONNECTABLE TO I/O DEVICE, INFORMATION PROCESSING APPARATUS AND METHOD OF CONTROLLING APPARATUS

(75) Inventor: Hirofumi KONNO, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/713,308

(22) Filed: Feb. 26, 2010

(30) Foreign Application Priority Data
Mar. 6, 2009 (JP) 2009-052973

(51) Int. Cl. G06F 11/14; G06F 13/00; G06F 13/36

(52) U.S. Cl. 714/49; 710/305; 710/315; 714/E11.002; 710/317

(57) ABSTRACT

An apparatus connected to a first and second buses, the apparatus having a first controller that transforms first form data into second form data, transforms second form data into first form data, and outputs the transformed data, a second controller that transforms first form data into second form data, transforms second form data into first form data, and outputs the transformed data, a first distributing unit connected to the first and second controllers, the first distributing unit distributing first form data to the first and second controllers, respectively, a first selector that selects one of the second form data, and outputs the selected data, a second distributing unit connected to the first and the second controllers, the second distributing unit distributing second form data to the first and second controllers, respectively, and a second selector that selects one of the first form data, and outputs the selected data

### CROSS-REFERENCE TO RELATED APPLICATION

This application is based upon and claims the benefit of priority of the prior Japanese Patent Application No. 2009-052973, filed on Mar. 6, 2009, the entire contents of which are incorporated herein by reference.

### FIELD

The present art relates to an apparatus having first bus and second bus connectable to I/O device, information processing apparatus and method of controlling apparatus.

### BACKGROUND

SAS (Serial Attached SCSI) is available as a connection interface between a computer system and a device such as an HDD (Hard Disk Drive).

Although a method of making the SAS device equipment redundant for general use (such as a RAID (Redundant Arrays of Independent Disks) function) is known, a device in which the SAS controller itself is made redundant is not yet proposed. Thus, if the SAS controller itself fails, data stored upon occurrence of a failure may not be guaranteed. In addition, since the SAS controller lacks redundancy, if the SAS controller fails, the SAS device equipment connected to the SAS controller turns to a disabled state. In particular, in the case that an operating system of the computer system is stored in the SAS device equipment such as the HDD, continuous operation of the computer system may become impossible.

Although a means for using software such as a driver and an application and switching operation after the software has recognized an error is known, a method of making a SAS controller redundant with no error recognition by software is not yet proposed. In addition, adoption of a method of doubling a bus which is incidental to use of software leads to an increase in scale of a hardware configuration because desired equipment is to be installed and hence the cost involved is increased. In addition, if a temporal error generates, execution of retry processing becomes necessary.

The present invention has been made in order to solve the above mentioned problems. Thus, it is desirable to provide a bus switch device capable of making a SAS controller redundant, an information processing apparatus including the above mentioned bus switch device and a controlling method for the above mentioned bus switch device.

[Patent Document 1] Japanese Laid-open Patent Publication No. 2006-107151

[Patent Document 2] Japanese Laid-open Patent Publication No. 2006-309375

[Patent Document 3] Japanese Laid-open Patent Publication No. 2007-148621

### SUMMARY

According to an aspect of an embodiment, an apparatus connected to a first bus and a second bus, the apparatus having a first controller that transforms first form data into second form data, transforms second form data into first form data, and outputs the transformed data, a second controller that transforms first form data into second form data, transforms second form data into first form data, and outputs the transformed data, a first distributing unit connected to the first controller and the second controller, the first distributing unit distributes first form data transmitted through the first bus to the first controller and the second controller, respectively, a first selector that selects one of the second form data outputted from the first and second controllers, and outputs the selected second form data to the second bus, a second distributing unit connected to the first controller and the second controller, the second distributing unit distributes second form data transmitted through the second bus to the first controller and the second controller, respectively, and a second selector that selects one of the first form data outputted from the first and second controllers, and outputs the selected first form data to the first bus.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a configuration of an information processing apparatus according to an embodiment of the present invention;

FIG. 2 is a diagram illustrating an example of a configuration of a bus switch device according to an embodiment of the present invention;

FIG. 3A is a diagram illustrating an example of a configuration of a SAS redundancy control unit according to an embodiment of the present invention;

FIG. 3B is a diagram illustrating an example of a configuration of a SAS selector according to an embodiment of the present invention;

FIG. 4A is a diagram illustrating an example of a configuration of a PCIe (PCI-Express) redundancy control unit according to an embodiment of the present invention;

FIG. 4B is a diagram illustrating an example of a configuration of a PCIe (PCI-Express) selector according to an embodiment of the present invention;

FIG. 5A is a flowchart (Part 1) illustrating an example of operations of a bus switch device according to an embodiment of the present invention;

FIG. 5B is a flowchart (Part 2) illustrating an example of operations of a bus switch device according to an embodiment of the present invention;

FIG. 5C is a flowchart (Part 3) illustrating an example of operations of a bus switch device according to an embodiment of the present invention;

FIG. 5D is a flowchart (Part 4) illustrating an example of operations of a bus switch device according to an embodiment of the present invention; and

FIG. 6 is a block diagram illustrating connection of equipment using an existing SAS interface.

### DESCRIPTION OF EMBODIMENT

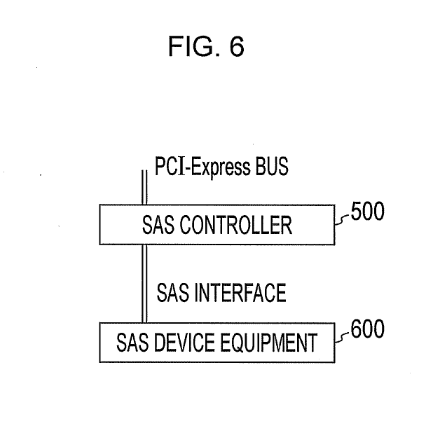

FIG. 6 is a block diagram illustrating connection of equipment having an existing SAS interface. A SAS controller 500 is a controller including an interface for a PCI-Express (Peripheral Component Interconnect Express) bus (a first bus) (denoted as “PCIe” in the FIG. 6) and a SAS interface (a second bus) and configured to perform data conversion between data of a data format (a first format) used on the PCI-Express bus and data of a data format (a second format) used on the SAS interface and to control the operation of SAS device equipment 600 such as an HDD.

The SAS controller 500 issues a command to the SAS device equipment 600 in accordance with a command received over the PCI-Express bus and controls the operation of the SAS device equipment 600. The SAS device equipment 600 is a storage device such as the HDD as described above, a RAID (Redundant Arrays of Independent Disks) device and a tape unit and is of the type equipped with the SAS interface as an interface for connection.

The PCI-Express bus is a general-purpose interface for extension used in personal computer equipment or a server system. The SAS interface is a general-purpose interface used for connection of devices such as the above mentioned HDD and tape unit in the personal computer equipment and the server system.

The personal computer equipment and the server system transmit data to the SAS device equipment such as the above mentioned HDD, RAID device and tape unit and receive data from the SAS device equipment.

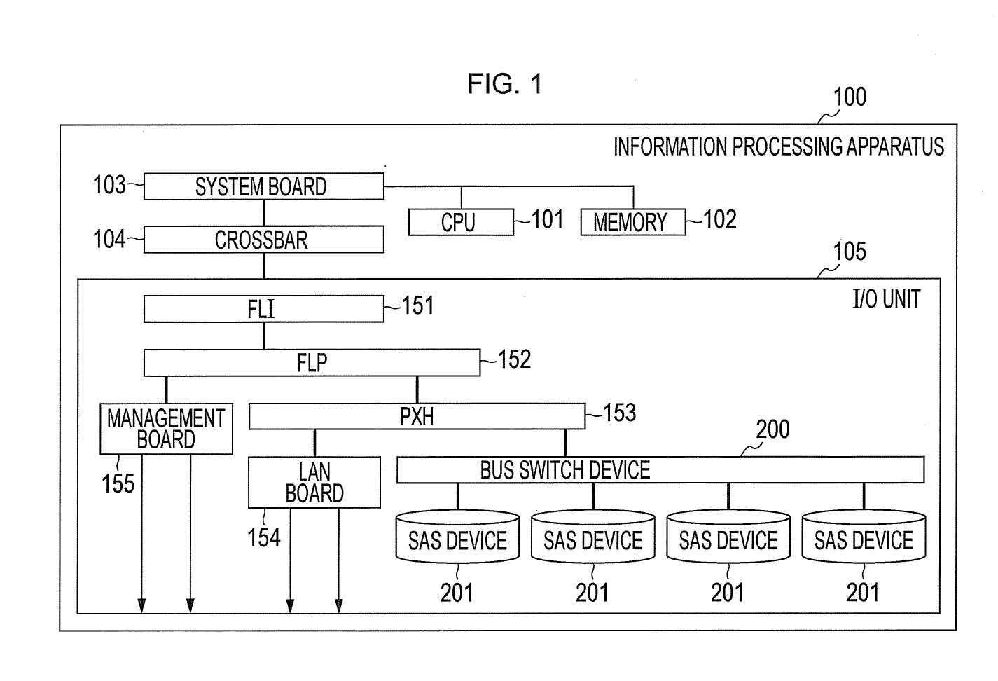

FIG. 1 is a diagram illustrating a hardware configuration of an information processing apparatus according to an embodiment of the present invention. An information processing apparatus 100 includes a CPU (Central Processing Unit) 101 constituting an arithmetic processing unit, a memory 102 constituting a data holding storage unit and a system board 103 constituting a main board connected with the CPU 101 and the memory 102. The information processing apparatus 100 also includes an I/O (Input Output) unit 105 constituting an input/output unit having equipment such as a LAN (Local Area Network) board and hard disks and a crossbar 104 for inter-coupling the system board 103 and the I/O unit 105.

The I/O unit 105 has an FLI 151, an FLP 152, a PXH 153, a LAN board 154, a management board 155, a bus switch device 200 and SAS devices 201.

The FLI 151 is an LSI for controlling the interface between the crossbar 104 and the FLP 152. The FLP 152 is an LSI for controlling the interfaces between the FLI 151 and the PXH 153 and between the FLI 151 and the management board 155 and may be capable of controlling the interfaces over a PCI-Express bus.

The PXH 153 is an LSI for controlling switching between the PCI-Express bus and a PCI bus. The LAN board 154 is a board for establishing a LAN communication line between an external information processing apparatus and the information processing apparatus 100. The management board 155 is a board for monitoring the power source, the temperature, the voltage and others in the external apparatus or the information processing apparatus 100.

The bus switch device 200 is a device which has realized redundancy of an existing SAS controller and may make connection between the PXH 153 and the SAS device 201 possible. The SAS device 201 is a device including a SAS interface to realize SAS-based connection and is constituted by a magnetic disk device according to an embodiment of the present invention. Incidentally, the above mentioned devices other than the bus switch device 200 and respective LSIs used therein are of well known or existing types.

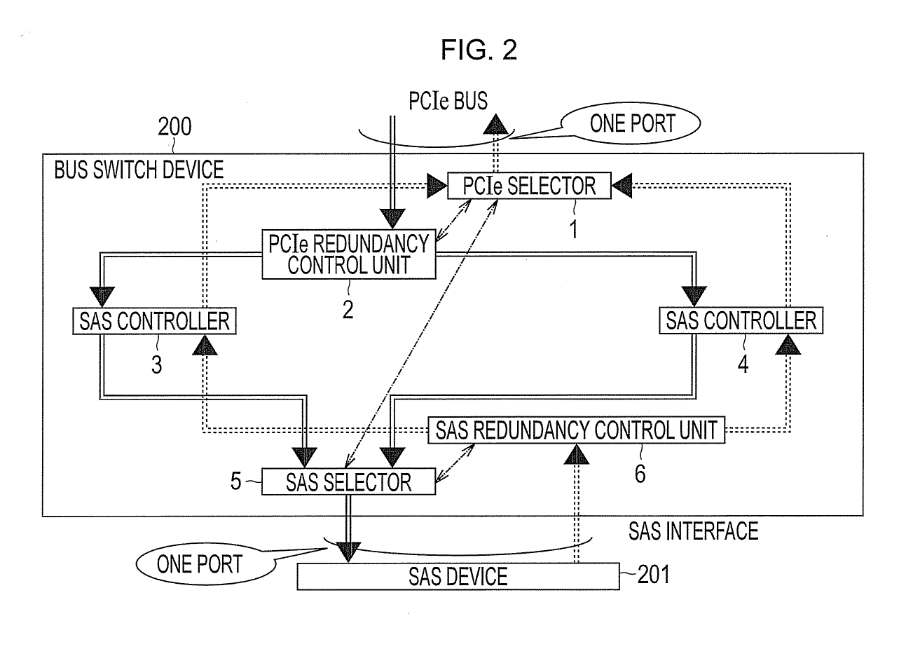

Next, a configuration of the bus switch device 200 will be described with reference to FIG. 2. Respective units installed in the bus switch device 200 which will be described hereinbelow are implemented on LSIs.

The bus switch device 200 includes a SAS controller 3 (a first bus switch circuit), a SAS controller 4 (a second bus switch circuit), a PCI-Express redundancy control unit 2 (a first distribution circuit) (denoted as “PCIe redundancy control unit 2” in FIG. 2), a SAS selector 5 (a second selection circuit), a SAS redundancy control unit 6 (a second distribution circuit) and a PCIe selector 1 (denoted as “PCIe selector 1” in FIG. 2) (a first selection circuit).

The SAS controllers 3 and 4 are controllers including an interface for a PCI-Express bus and a SAS interface to control the SAS device 201. That is, each of the SAS controllers 3 and 4 issues a command to the SAS device 201 in accordance with a command received over the PCI-Express bus to control the SAS device 201. Incidentally, the SAS controllers 3 and 4 are known SAS controllers which have been described with reference to FIG. 6. According to an embodiment of the present invention, in order to configure a redundant SAS controller, two controllers of the SAS controller 3 and the SAS controller 4 are prepared.

The PCI-Express redundancy control unit 2 is installed on the way of a transmission signal line extending from the PCI-Express bus to each of the SAS controllers 3 and 4 and has a function of distributing transmission signals set over the PCI-Express bus to the SAS controllers 3 and 4. The PCI-Express redundancy control unit 2 produces a pair of the first form data and distributes the pair of the first form data.

The SAS selector 5 is installed on the way of of a transmission signal line extending from each of the SAS controllers 3 and 4 to the SAS devices 201. The SAS device 201 and is configured to switch a signal to be transmitted to the SAS device 201. The SAS selector 5 includes an error detecting section so as to switch from the SAS controller 3 to the SAS controller 4 or vice versa when an error is detected in one of the controllers.

The SAS redundancy control unit 6 is installed on the way of a transmission signal line extending from the SAS device equipment 201 to each of the SAS controllers 3 and 4 and has a function of distributing transmission signals sent from the SAS devices 201 to the SAS controllers 3 and 4. The SAS redundancy control unit 6 produces a pair of the second form data and distributes the pair of the second form data.

The PCI-Express selector 1 is installed at an intermediate position of a transmission signal line extending from each of the SAS controllers 3 and 4 to the PCI-Express bus to switch a signal to be transmitted to the PCI-Express bus. The PCI-Express selector 1 includes an error detecting section so as to switch from the SAS controller 3 to the SAS controller 4 or vice versa when an error is detected in one of the controllers.

Incidentally, the PCI-Express selector 1 cooperates with the SAS selector 5 so as to perform switching in synchronization with each other when one of them detects an error in one of the controllers and switches to the controller with no error.

Next, operations of the bus switch device 200 will be described. Data is transmitted over the PCI-Express bus to the PCI-Express redundancy control unit 2 which transmits the received data of the same content to both the SAS controllers 3 and 4. The data transmitted via the SAS controllers 3 and 4 is temporarily stored in a buffer of the SAS selector 5. The SAS selector 5 checks to see whether the data has been transmitted from both the SAS controllers 3 and 4. As a result, respective pieces of data sent from both the SAS controllers are synchronized with each other using the SAS selector 5. One piece of data which has been selected using the SAS selector 5 is transmitted to the SAS device equipment 201.

Data which has been processed using the SAS device equipment 201 is received by the SAS redundancy control unit 6 which transmits the data of the same content to both the SAS controllers 3 and 4. The data transmitted via the SAS controllers 3 and 4 is temporarily stored in a buffer of the PCI-Express selector 1. The PCI-Express selector 1 checks to see whether the data has been sent from both the SAS controllers 3 and 4. One piece of data which has been selected using the PCI-Express selector 1 is output to the PXH 153 over the PCI-Express bus.

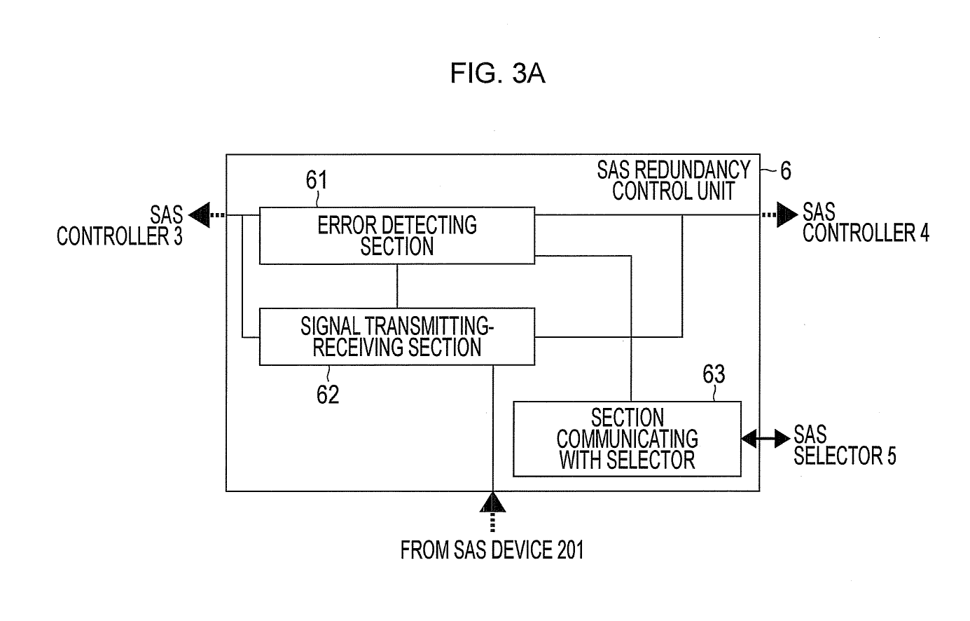

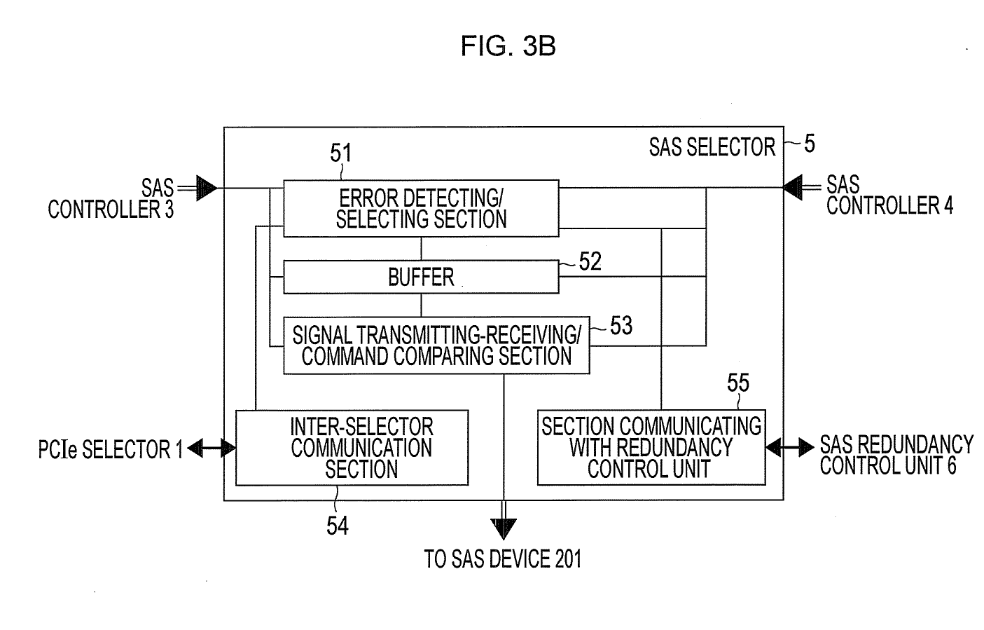

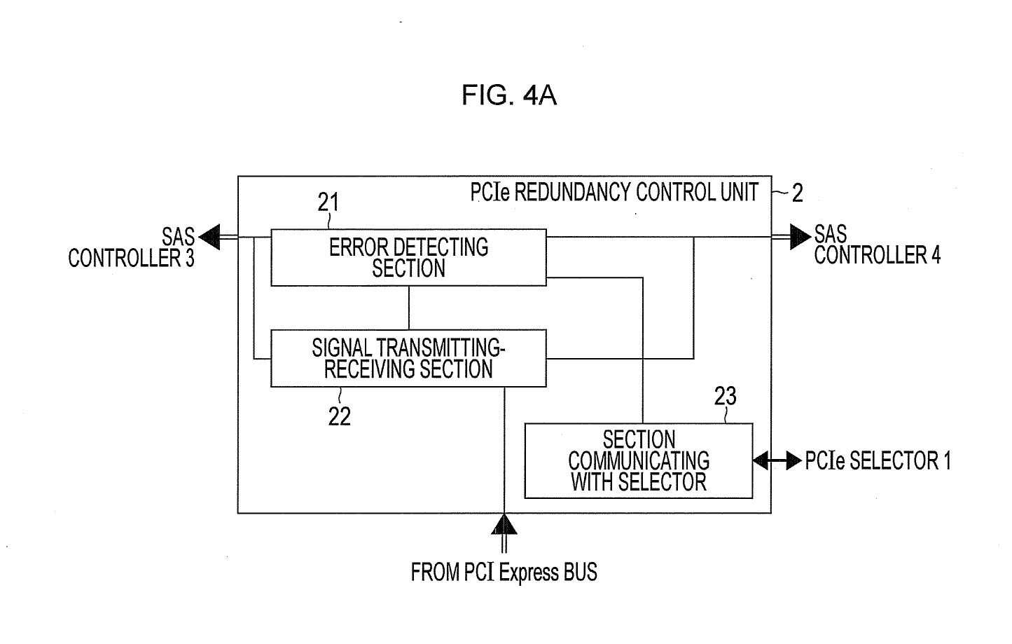

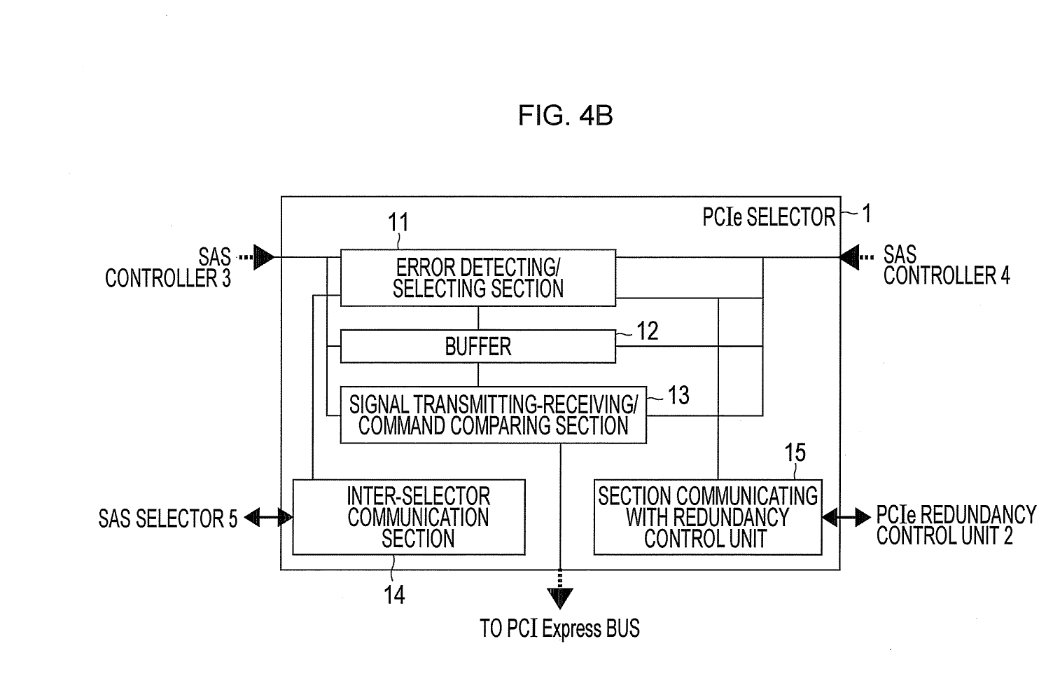

FIG. 3A, FIG. 3B, FIG. 4A and FIG. 4B respectively illustrate internal configurations of the SAS redundancy control unit 6, the SAS selector 5, the PCI-Express redundancy control unit 2 and the PCI-Express selector 1 and details of processes performed using the respective units will be described with reference to the respective drawings. Incidentally, FIG. 3A and FIG. 3B respectively illustrate the internal configurations of the SAS redundancy control unit 6 and the SAS selector 5 and FIG. 4A and FIG. 4B respectively illustrate the internal configurations of the PCI-Express redundancy control unit 2 and the PCI-Express selector 1.

First, details of the SAS redundancy control unit 6 will be described with reference to FIG. 3A. The SAS redundancy control unit 6 has connection ports through which it is connected with the SAS controllers 3 and 4 (hereinafter, referred to as ports for connection with the SAS controllers 3 and 4) and a port for connection with the SAS device 201. Normally, a signal from the SAS device 201 is transmitted to the SAS controllers 3 and 4 using a signal transmitting-receiving section 62. In the above mentioned situation, in the case that an error detecting section 61 has detected one or both of link cut-off and a CRC (Cyclic Redundancy Check) error at the port(s) for connection with the SAS controller(s) 3 and/or 4, a section 63 for communicating with the selectors transmits a switch signal to the SAS selector 5. Then, the PCI-Express selector 1 and the SAS selector 5 respectively perform switching as to whether a data signal from the SAS controller 3 or a data signal from the SAS controller 4 is to be adopted.

In the case that an abnormality has been sensed at the port for connection with the SAS controller 3 in a state while both the systems are operating, the SAS redundancy control unit 6 transmits the signal from the SAS device 201 only to the SAS controller 4. On the other hand, in the case that an abnormality has been sensed at the port for connection with the SAS controller 4 in the state that both the systems are operating, the SAS redundancy control unit 6 records that the abnormality has been sensed.

A switch signal for switching from the SAS controller 3 to the SAS controller 4 or vice versa is sent to the SAS selector 5 via a signal line (a one-dot chain line in FIG. 2) directly coupling the SAS redundancy control unit 6 to the SAS selector 5. The switch signal is also sent to the PCI-Express redundancy control unit 2 via a signal line (a double broken line (in FIG. 2) directly coupling the SAS selector 5 to the PCI-Express selector 1 and then is sent to the PCI-Express redundancy control unit 2 via a signal line (a one-dot chain line in FIG. 2) directly coupling the PCI-Express selector 1 to the PCI-Express redundancy control unit 2.

In the case that an abnormality has been sensed at one port in a state in which an abnormality has already occurred at the other connection port, the same operation as that has ever been performed is performed. That is, the SAS device 201 is locked out using a software-based monitoring function.

Next, details of the SAS selector 5 will be described with reference to FIG. 3B. The SAS selector 5 has ports for connection with the SAS controllers 3 and 4 and a port for connection with the SAS device 201. In the case that both the SAS controllers 3 and 4 normally operate, a data signal from the SAS controller 3 and a data signal from the SAS controller 4 are temporarily held in a buffer 52 using a signal transmitting-receiving/command comparing section 53 and then the data signal from the SAS controller 3 and the data signal from the SAS controller 4 are checked. Then, only the data signal from the SAS controller 3 is transmitted to the SAS device 201.

One SAS controller is switched to the other SAS controller on condition that one or both of link cut-off and a CRC error has or CRC erros have been detected at the port(s) for connection with the SAS controller(s) 3 and/or 4 using an error detecting/selecting section 51 (an error detecting section).

For example in the case that an abnormality has been sensed at the port for connection with the SAS controller 3 in a state in which both the systems are operating, a packet from the SAS controller 3 is discarded and the data signal received from the SAS controller 4 is transmitted to the SAS device 201. On the other hand, in the case that an abnormality has been sensed at the port for connection with the SAS controller 4 in the state in which both the systems are operating, the SAS selector 5 records in a buffer 52 that the abnormality has been sensed, for example.

A switch signal for switching from the SAS controller 3 to the SAS controller 4 or vice versa is sent to the PCI-Express selector 1 via a signal line directly coupling the SAS selector 5 to the PCI-Express selector 1 and then is sent to the PCI-Express redundancy control unit 2 via a signal line directly coupling the PCI-Express selector 1 to the PCI-Express redundancy control unit 2. The switch signal is also sent to the SAS redundancy control unit 6 via a signal line directly coupling the SAS selector 5 to the SAS redundancy control unit 5.

In the case that an abnormality has been sensed at one port in a state in which an abnormality has already occurred at the other connection port, the same operation as that has ever been performed is performed. That is, the SAS device 201 is locked out using a software-based monitoring function.

Next, details of the PCI-Express redundancy control unit 2 will be described with reference to FIG. 4A. The PCI-Express redundancy control unit 2 (denoted as “PCIe redundancy control unit 2” in the FIG. 4A) has ports for connections with the SAS controllers 3 and 4 and a port for connection with the PCI-Express bus.

Normally, a signal sent over the PCI-Express bus is transmitted to the SAS controllers 3 and 4 using a signal transmitting -receiving section 22.

In the case that an error detecting section 21 has sensed one or both of link cut-off and a CRC error at the port(s) for connection with the SAS controller(s) 3 and/or 4, a switch signal is transmitted via a section 23 for communicating with the selectors and the PCI-Express selector 1 (denoted as “PCIe selector 1” in the FIG. 4A″) and the SAS selector 5 respectively perform switching as to whether a data signal from the SAS controller 3 or a data signal from the SAS controller 4 is to be adopted.

For example in the case that an abnormality has been sensed at the port for connection with the SAS controller 3 in a state in which both the systems are operating, the signal transmitting-receiving section 22 transmits the signal sent over the PCI-Express bus only to the SAS controller 4. On the other hand, in the case that an abnormality has been sensed at the port for connection with the SAS controller 4 in the state in which both the systems are operating, the signal transmitting-receiving section 22 records that the abnormality has been sensed at the port for connection with the SAS controller 4.

A switch signal for switching from the SAS controller 3 to the SAS controller 4 or vice versa is sent to the PCI-Express selector 1 via a signal line directly coupling the PCI-Express redundancy control unit 2 to the PCI-Express selector 1. The switch signal is also sent to the SAS selector 5 via a signal line directly coupling the PCI-Express selector 1 to the SAS selector 5 and the switch signal is sent to the SAS redundancy control unit 6 via a signal line directly coupling the SAS selector 5 to the SAS redundancy control unit 6.

In the case that an abnormality has been sensed at one port in a state in which an abnormality has already occurred at the other connection port, the same operation as that has ever been performed is performed. That is, the SAS device equipment 201 is locked out using a software-based monitoring function.

Next, details of the PCI-Express selector 1 will be described with reference to FIG. 4B. The PCI-Express selector 1 (denoted as “PCIe” in the FIG. 4B) has ports for connection with the SAS controllers 3 and 4 and a port for connection with the PCI-Express bus.

Normally, data signals from the SAS controllers 3 and 4 are temporarily held in a buffer 12 and checked using a signal transmitting-receiving/command comparing section 13, and then the data signal from the SAS controller 3 is transmitted to the PCI-Express bus.

One controller is switched to the other controller on condition that one or both of link cut-off and a CRC error has (have) been detected at the port(s) for connection with the SAS controller(s) 3 and/or 4 using an error detecting/selecting section 11 (an error detecting section).

For example in the case that an abnormality has been sensed at the port for connection with the SAS controller 3 in a state in which both the systems are operating, a packet from the SAS controller 3 is discarded and the data signal received from the SAS controller 4 is transmitted to the PCI-Express bus. On the other hand, in the case that an abnormality has been sensed at the port for connection with the SAS controller 4 in the state in which both the systems are operating, data that the abnormality has been sensed is recorded.

A switch signal for switching from the SAS controller 3 to the SAS controller 4 or vice versa is sent to the SAS selector 5 via a signal line directly coupling the PCI-Express selector 1 to the SAS selector 5 and then is sent to the SAS redundancy control unit 6 via a signal line directly coupling the SAS selector 5 to the SAS redundancy control unit 6. The switch signal is also sent to the PCI-Express redundancy control unit 2 via a signal line directly coupling the PCI-Express selector 1 to the PCI-Express redundancy control unit 2.

In the case that an abnormality has been sensed at one port in a state in which an abnormality has already occurred at the other connection port, the same operation as that has ever been performed is performed. That is, the SAS device equipment 201 is locked out using a software-based monitoring function.

Incidentally, as for detection of the above mentioned CRC error, a calculation method performed in accordance with the rules of respective architectures (the PCI-Express bus and the SAS interface in an embodiment of the present invention) is adopted.

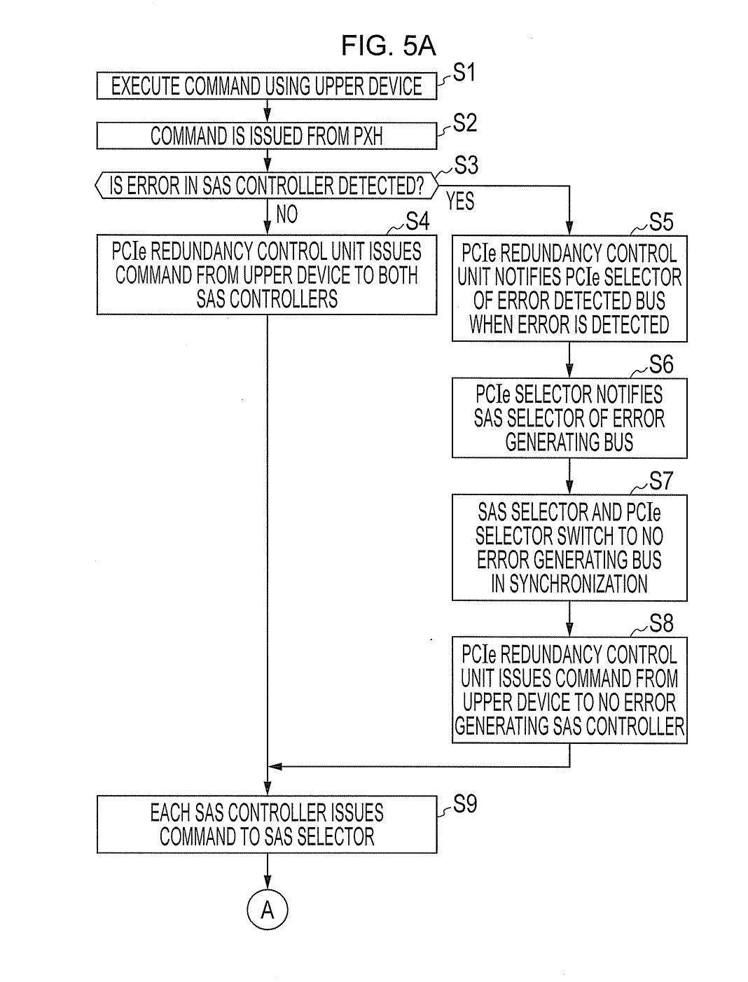

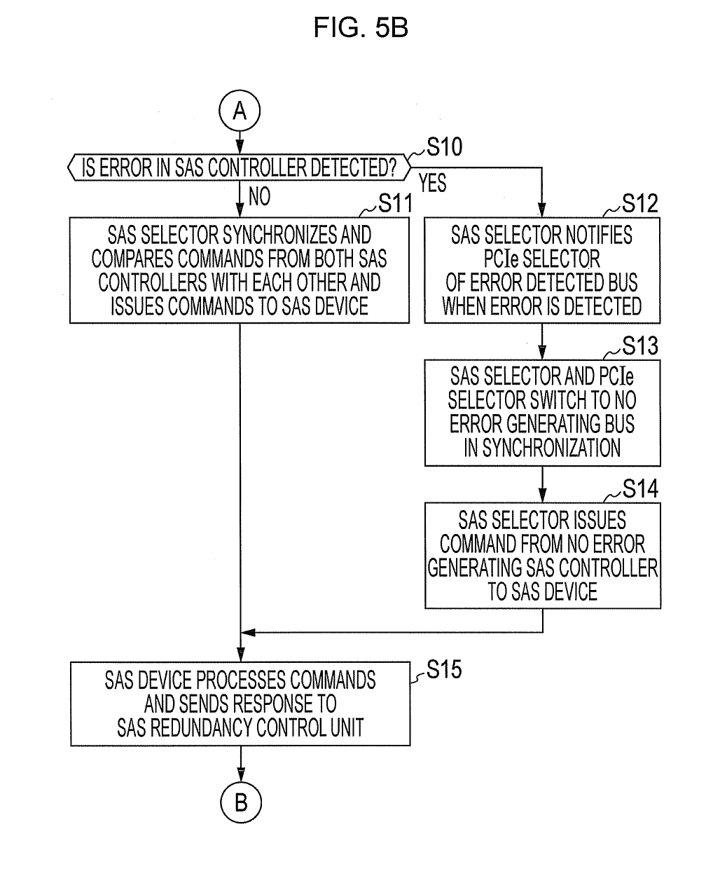

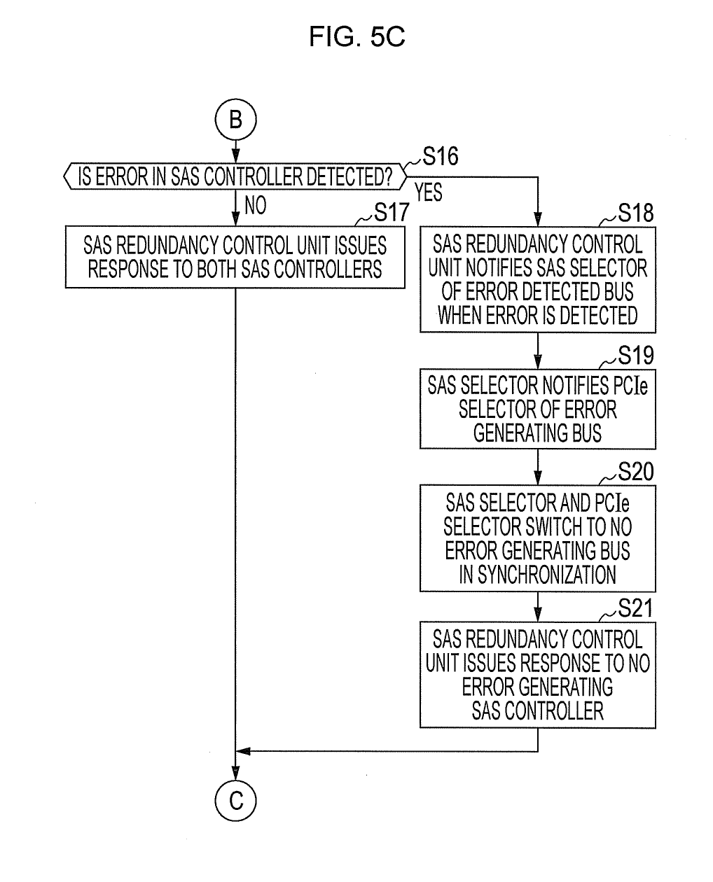

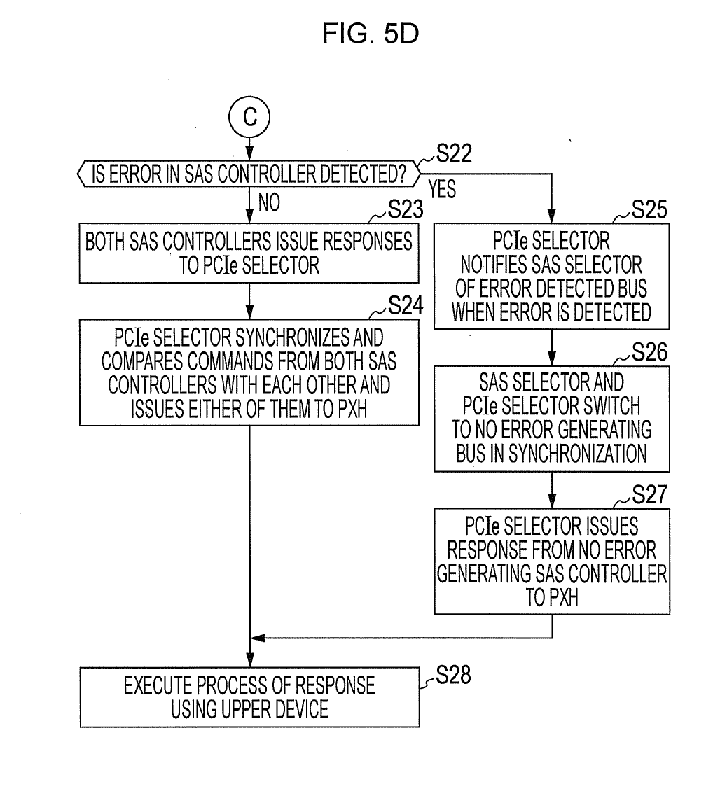

Next, operations of the bus switch device 200 will be described with reference to the flowchart illustrated in FIGS. 5A to 5D.

For example, when a command is executed using an upper device, for example, by giving a write instruction or a read instruction from a user to the SAS device 201 (S1), a command in accordance with the executed command is issued from the PXH 153 (S2). In the above mentioned situation, in the case the PCI-Express redundancy control unit 2 (denoted as “PCIe redundancy control unit 2” in the FIG. 5″) has detected an error in the SAS controller 3 or 4 (S3, Yes), the PCI-Express redundancy control unit 2 notifies the PCI-Express selector 1 (denoted as “PCIe selector 1” in the FIG. 5″) of a bus (the above mentioned switch signal) of an error detected controller (S5). The PCI-Express selector 1 notifies the SAS selector 5 of the error generating bus (S6). The SAS selector 5 and the PCI-Express selector 1 switch to a no error generating bus in synchronization with each other (S7). The PCI-Express redundancy control unit 2 issues the command received from the upper device to the no error generating SAS controller (S8).

On the other hand, in the case that the PCI-Express redundancy control unit 2 does not detect an error in the SAS controller 3 or 4 at S3 (S3, No), the PCI-Express redundancy control unit 2 issues the command received from the upper deice to both the SAS controllers 3 and 4 (S4).

The SAS controllers to which the command has been issued issue commands to the SAS selector 5 (S9). In the above mentioned situation, the SAS selector 5 which has received the commands judges by itself whether an error is detected in the SAS controller 3 or 4 (S10). In the case that the error is detected in the SAS controller 3 or 4 (S10, Yes), the SAS selector 5 notifies the PCI-Express selector 1 of an error detected bus (S12) and the SAS selector 5 and the PCI-Express selector 1 switch to a no error generating bus in synchronization with each other (S13). The SAS selector 5 issues the command from a no error generating SAS controller to the SAS device 201 (S14).

On the other hand, in the case that the SAS selector 5 does not detect an error (S10, No), the SAS selector 5 synchronizes and compares the commands received from the SAS controllers 3 and 4 with each other and issues the commands to the SAS device 201 (S11).

The SAS device 201 processes the received commands and sends a response to the SAS redundancy control unit 6 (S15). Then, the SAS redundancy control unit 6 judges whether an error in one of the SAS controllers is detected by the SAS redundancy control unit 6 itself (S16). In the case that the error is detected by the SAS redundancy control unit 6 (S16, Yes), the SAS redundancy control unit 6 notifies the SAS selector 5 of an error detected bus (S18). The SAS selector 5 notifies the PCI-Express selector 1 of the error generating bus (S19) and then the PCI-Express selector 1 and the SAS selector 5 switch to a bus of a no error generating SAS controller in synchronization with each other (S20). The SAS redundancy control unit 6 issues the response from the SAS device 201 to the no error generating SAS controller (S21).

On the other hand, in the case that the SAS redundancy control unit 6 does not detect an error at S16 (S16, No), the SAS redundancy control unit 6 issues the response received from the SAS device 201 to both the SAS controllers 3 and 4 (S17) and the SAS controllers which have received the response issue responses to the PCI-Express selector 1.

The PCI-Express selector 1 judges whether an error in one of the SAS controllers is detected by itself (S22). In the above mentioned situation, in the case that the error is detected by the SAS redundancy control unit 6 (S22, Yes), the PCI-Express selector 1 notifies the SAS selector 5 of the error detected bus (S25) and the SAS selector 5 and the PCI-Express selector 1 switch to the bus of the no error generating SAS controller in synchronization with each other (S26). The PCI-Express selector 1 issues the response received from the no error generating SAS controller to the PXH 153 (S27).

On the other hand, in the case that an error is not detected at S22 (S22, No), the SAS controllers 3 and 4 issue responses to the PCI-Express selector 1 (S23), the PCI-Express selector 1 synchronizes and compares the responses received from the SAS controllers 3 and 4 with each other and then issues one of the received responses to the PXH 153 (S24).

The PXH 153 issues the response to the upper device and processing of the response is executed using the upper device (S28).

The information processing apparatus 100 and the bus switch device 200 according to the present embodiments may have effects as follows.

The information processing apparatus 100 and the bus switch device 200 may be capable of configuring a redundant SAS controller with no provision of either OSes or drivers and applications for use in a multi-path. In addition, owing to the SAS controller configured to be redundant, data is not lost for a single failure in the SAS controller and hence continuous use of the SAS device may become possible.

Even when a temporal error generates, transmission of normal data may be possible with not need of execution of the retry processing and hence high-speed execution of processing may become possible.

Equipment to be used is reduced, large-scale installation is not necessary and hence the cost involved is reduced.

Even if one of a first bus switch circuit and a second bus switch circuit fails, data will not be lost and continuous use of device equipment become possible.

As mentioned above, the present invention has been specifically described for better understanding of the embodiments thereof and the above description does not limit other aspects of the invention. Therefore, the present invention can be altered and modified in a variety of ways without departing from the gist and scope thereof.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. An apparatus connected to a first bus and a second bus, the apparatus comprising:
a first controller that transforms first form data into second form data, transforms second form data into first form data, and outputs the transformed data;
a second controller that transforms first form data into second form data, transforms second form data into first form data, and outputs the transformed data;
a first distributing unit connected to the first controller and the second controller, the first distributing unit distributes first form data transmitted through the first bus to the first controller and the second controller, respectively;
a first selector that selects one of the second form data outputted from the first and second controllers, and outputs the selected second form data to the second bus;
a second distributing unit connected to the first controller and the second controller, the second distributing unit distributes second form data transmitted through the second bus to the first controller and the second controller, respectively; and
a second selector that selects one of the first form data outputted from the first and second controllers, and outputs the selected first form data to the first bus.

2. The apparatus of claim 1, wherein the selector includes an error detection unit that detects an error of the data outputted from the first controller or the second controller.

3. The apparatus of claim 2, wherein the selector selects data inputted from one of the first controller or the second controller when the error detection unit detects an error of data inputted from the other of the first controller or the second controller.

4. The apparatus of claim 2, wherein when the error detection unit detects an error of data inputted from one of the first controller or the second controller, the selector instructs the other selector to select data inputted from the other of the first controller or the second controller.

5. The apparatus of claim 4, wherein the other selector selects the data inputted from the controller instructed by the selector.

6. The apparatus of claim 1, wherein the selector includes an error detection unit that detects an error of the selected data, and the selector selects data outputted from the controller other than the controller that outputted data in which an error is detected, when the error detection unit detected the error.

7. The apparatus of claim 6, wherein the second selector selects first form data inputted from the second controller when the error detection unit detects an error of first form data inputted from the first controller.

8. The apparatus of claim 6, wherein the error detection instructs the first selector to select second form data inputted from the second controller when the error detection unit detects an error of first form data inputted from the first controller.

9. The apparatus of claim 8, wherein the first selector selects the second form data inputted from the second controller.

10. An information processing apparatus comprising:
a memory that stores data;
a processor that carries out an operation on the data stored in the memory; and
a converter that connects a first bus and a second bus, including a first controller that transforms a first data of a first form data inputted from the first bus into second form data for the second bus, that transforms second form data inputted from the second bus into first form data for the first bus, and that outputs the transformed data, a second controller that transforms first form data inputted from the first bus into second form data, transforming second form data inputted from the second bus into first form data, and that outputs the transformed data, a first distributing unit that distributes the first form data inputted from the first bus to produce a pair of the first form data, and that respectively transmits one of the pair of the first form data to the first controller and the second controller, a first selector that selects one of second form data inputted from the first and second controllers, and that outputs the selected second form data to the second bus, a second distributing unit that distributes the second form data inputted from the second bus to produce a pair of the second form data, and that respectively transmits one of the pair of the second form data to the first controller and the second controller, and a second selector that selects one of the first form data inputted from the first and second controllers, and that outputs the selected first form data to the first bus.

11. The information processing apparatus of claim 10, wherein the first selector has an error detection unit that detects an error of the pair of second form data inputted from the first controller and the second controller, respectively.

12. The information processing apparatus of claim 11, wherein the first selector selects second form data inputted from the first controller when the error detection unit detects an error of second form data inputted from the second controller.

13. The information processing apparatus of claim 11, wherein the error detection instructs the second selector to select first form data inputted from the first controller when the error detection unit detects an error of second form data inputted from the second controller.

14. The information processing apparatus of claim 13, wherein the second selector selects the first form data inputted from the first controller.

15. A method of controlling an apparatus connected to a plurality of buses, the method comprising:
distributing first form data received through a first bus to a first controller and a second controller, respectively;
transforming, by the first controller and the second controller, the distributed first form data into second form data;
selecting one of the second form data outputted from the first controller and the second controller; and
outputting the selected second form data to a second bus.

16. The method of claim 15, further comprising:
detecting an error of the second form data outputted from the first controller or the second controller.

17. The method of claim 16, further comprising:
selecting second form data outputted from one of the controller when an error of second form data outputted from the other controller is detected.

18. The method of claim 15, further comprising:
detecting an error of the selected second form data; and
selecting second form data outputted from the controller other than the controller that has outputted second form data in which the error is detected.
